(19) United States
(12) Patent Application Publication
(10) Pub. No.: US 2024/0283816 A1
(43) Pub. Date: Aug. 22, 2024

(54) FIRMWARE PROTECTION METHOD, CONTROLLER, SYSTEM, DEVICE, AND STORAGE MEDIUM

(71) Applicant: Lenovo (Beijing) Limited, Beijing (CN)

(72) Inventors: Ming LEI, Beijing (CN); Xiao Li YIN, Beijing (CN)

(21) Appl. No.: 18/420,117

(22) Filed: Jan. 23, 2024

(30) Foreign Application Priority Data
Feb. 21, 2023 (CN) 202310145663.1

(51) Int. Cl. H04L 9/40; G06F 12/14

(52) U.S. Cl. CPC H04L 63/1458; G06F 12/1441

(57) ABSTRACT

A firmware protection method includes monitoring an access request to a storage device and obtaining access request data. The storage device is configured to store firmware. The method further includes, in response to the access request data, when determining that the access request is a denial-of-service (DOS) attack, performing write protection on a first region of the storage device, maintaining the power supply to the storage device, and allowing the storage device to be accessible by the firmware.

### CROSS-REFERENCE TO RELATED APPLICATION

The present disclosure claims priority to Chinese Patent Application No. 202310145663.1, filed on Feb. 21, 2023, the entire content of which is incorporated herein by reference.

### TECHNICAL FIELD

The present disclosure relates to the storage device technology field and, more particularly, to a firmware protection method, a controller, a system, a device, and a storage medium.

### BACKGROUND

In the related technology, access to a storage device is monitored. When a DOS (Denial of Service) attack is detected, the storage device is isolated, and the power source of the storage device is removed.

However, in this scenario, the storage device cannot be accessed or can be powered off repeatedly. If firmware needs to access the storage device, an unforeseen error may appear, which causes a failure in the management ability and even the failure in the firmware.

### SUMMARY

An aspect of the present disclosure provides a firmware protection method. The method includes monitoring an access request to a storage device and obtaining access request data. The storage device is configured to store firmware. The method further includes, in response to the access request data, when determining that the access request is a denial-of-service (DOS) attack, performing write protection on a first region of the storage device, maintaining power supply to the storage device, and allowing the storage device to be accessed including allowing the firmware to access the storage device.

An aspect of the present disclosure provides a controller, including an attack protection assembly. The attack protection assembly is configured to monitor an access request to a storage device and obtain access request data. The storage device is configured to store firmware. The attack protection assembly is further configured to, in response to the access request data, when determining that the access request is a denial-of-service (DOS) attack, perform write protection on a first region of the storage device, maintain power supply to the storage device, and allow the storage device to be accessed including allowing the firmware to access the storage device.

An aspect of the present disclosure provides an electronic device, including a processor and a memory. The memory stores a computer program that, when executed by the processor, causes the processor to monitor an access request to a storage device and obtain access request data. The storage device is configured to store firmware. The processor is further configured to, in response to the access request data, when determining that the access request is a denial-of-service (DOS) attack, perform write protection on a first region of the storage device, maintain power supply to the storage device, and allow the storage device to be accessed including allowing the firmware to access the storage device.

### BRIEF DESCRIPTION OF THE DRAWINGS

FIG. 1 illustrates a schematic flowchart of a firmware protection method according to some embodiments of the present disclosure.

FIG. 2 illustrates a schematic diagram of a storage device according to some embodiments of the present disclosure.

FIG. 3 illustrates a schematic structural diagram of a firmware protection system according to some embodiments of the present disclosure.

FIG. 4 illustrates a schematic structural diagram of a controller according to some embodiments of the present disclosure.

FIG. 5 illustrates a schematic structural diagram of another firmware protection system according to some embodiments of the present disclosure.

FIG. 6 illustrates a schematic diagram showing a hardware entity of an electronic device a chip according to some embodiments of the present disclosure.

### DETAILED DESCRIPTION OF THE EMBODIMENTS

The technical solution of the present disclosure is further described in detail in connection with the accompanying drawings and embodiments of the present disclosure.

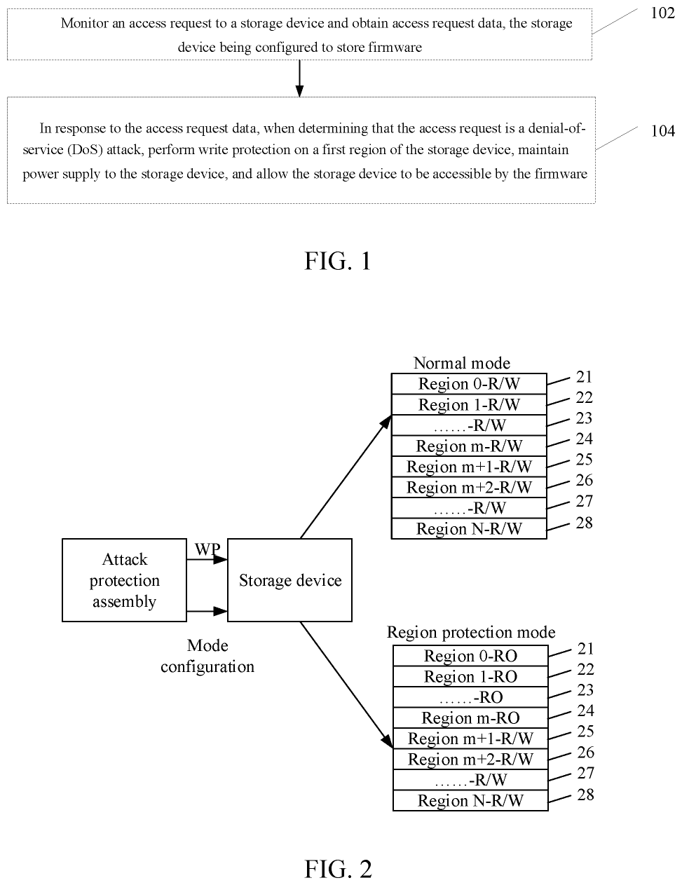

FIG. 1 illustrates a schematic flowchart of a firmware protection method according to some embodiments of the present disclosure. As shown in FIG. 1, the method includes the following processes.

At 102, access to a storage device is monitored to obtain access request data, and the storage device is configured to save firmware.

The firmware is software providing lower-level control for server hardware, which is very important for the stability and manageability of the server. Thus, a resilience capability can be essential for the firmware. The firmware is usually stored in the storage device. The storage device can include a non-volatile flash storage device, a random access memory (RAM), and a read-only memory (ROM). The non-volatile flash storage device can also be referred to as a flash device.

The firmware can include a baseboard management controller (BMC), a unified extensible firmware interface (UEFI), and management engine (ME) firmware running on a PCH.

At 104, in response to the access request data, when the access request is determined to refuse service for the DOS attack, writing protection is performed on a first region of the storage device, the power source is maintained for providing power to the storage device, and the storage device is allowed to be accessed to allow the firmware to access the storage device.

Access request data carried in the access request can be obtained. According to the access request data, whether the access request is a Denial of Service (DOS) attack. When the access request is a DOS attack, a region protection mode can be configured for the storage device based on the layout of the storage device. The region protection mode can include performing write protection on a region that needs protection. The region that needs protection can include a first region of the storage device. Performing the write protection on the first region can include setting data of the first region to a read-only mode or a read-only mode with no deletion allowed. When the access request is a DOS attack, the storage device may be no longer isolated, or the power source of the storage device may be no longer removed. Thus, the storage device can be accessed.

In some embodiments of the present disclosure, when a DOS attack is detected, the first region can be divided at the storage device for performing the write protection. Thus, the isolated region can be reduced to lower the strength of the DOS attack. Since the storage device is no longer isolated, or the power source of the storage device is no longer removed, the storage device can be accessed. When the firmware needs to access the storage device, the risk of error can be lowered, and the risk of losing manageability and firmware failures can be lowered.

In some embodiments, the method further includes dividing the storage region of the storage device into the first region and a second region (101).

At least a portion of the first region can be used to store the firmware.

In some embodiments, the write protection can be performed on the region of the storage device for storing the firmware to avoid damages to the region for storing the firmware caused by writing, modification, and deletion.

In some embodiments, the first region can include a read-only region. The second region can include a read-write region. Dividing the storage region of the storage device into the first region and the second region can include dividing the storage region of the storage device into the write and read region and the read-only region with sectors as units.

As shown in FIG. 2, the storage device at least can include sectors 21 to 28. In the region protection mode of the storage device, the storage region of the storage device can be divided into read-only region 0, read-only region 1, . . . , read-only region m, read-write region m+1, read-write region m+2, . . . , read-write region N, where m=(0, 1). A read-only region can be represented as RO, and a read-write region can be represented as R/W.

Through the written protect (WP) assert, WP pins of the storage device can enter the region protection mode of the storage device to protect the status register from being written.

In some embodiments, the layout of the storage device can be optimized to use sectors as units to separate the read-only region and the read-write region to more efficiently manage the region of the storage device in regions and perform write protection on the read-only region.

In some embodiments, the method further includes determining the access mode and access times of the access request (1031) and determining the access request as a DOS attack when the access mode is violated access and the access times exceed a predetermined threshold (1032).

The access mode can include violated access and non-violated access. The non-violated access can also be referred to as compliant access. The access mode can include an access type to the data being accessed. The access type can include read access, erase access, write access, etc. When the data being accessed is in the read-only mode, and the access type is the read access, the access mode can be the complaint access. When the data being accessed is in the read-only mode, and the access type is the erase access or write access, the access can be the violated access.

A number of violated accesses recorded by the firmware during running at a fixed time interval at T1, T2, . . . , Tn, Tn+1, . . . , Tm. As shown in formula (1), if an average number of violated accesses in a most recent time T(m−n) (i.e., from time Tn to time Tm) exceeds a predetermined threshold TH1, then the DOS attack can be confirmed.

$$\frac{{\sum }_{t = {T}_{n}}^{{T}_{m}} {N}_{t}}{{T}_{m} - {T}_{n}} > TH 1 \qquad ( 1 )$$

In some embodiments of the present disclosure, whether the access request is the DoS attack can be determined according to whether the access mode is the violated access and the number of access times to more accurately determine the DOS attack.

In some embodiments, the method further includes notifying the firmware that the storage device is under the DOS attack to let the firmware inform the user of the inspection and/or solution methods for the DOS attack (105).

The firmware can be notified that the storage device is under the DOS attack. The firmware can then alert the user that the storage device is under the DOS attack of the violated access and recommend to the user how to inspect/resolve the violated access. In some embodiments, notification information can be sent to the firmware for outputting prompt information. The notification information can be used to notify the firmware that the storage device is under the DOS attack. The prompt information can be used to notify the user that the storage device is under the DOS attack. The prompt information can further include the inspection and/or solution methods of the DOS attack.

In embodiments of the present disclosure, when the storage device is under the DoS attack, the firmware is notified to prompt the user that the storage device is under the DOS attack and notify the user of the inspection and/or solution method for the DOS attack. Thus, the DoS attack can be inspected and resolved in time to improve the security of the data access.

In some embodiments, the method further comprises determining that the DOS attack stops when the number of accesses is less than or equal to the predetermined threshold (106) and removing the write protection to the first region of the storage device (107).

If the average number of violated accesses during the previous time T(m−n) is less than the predetermined threshold, the attack protection assembly can determine that the DOS attack stops. Through WP de-assert, the WP pins of the flash device can be released to exit the region protection mode to a normal mode and remove the write protection to the first region. As shown in FIG. 2, when under a DOS attack, the write protection is performed on read-only region 0, read-only region 1, . . . , read-only region m. When there is no DOS attack or the DOS attack stops, the write protection for the first region can be removed. That is, read-only region 0, read-only region 1, . . . , read-only region m can return to the R/W mode.

In some embodiments of the present disclosure, when the number of accesses is less than or equal to the predetermined threshold, it is determined that the DOS attack has stopped.

Thus, whether the DOS attack stops can be more conveniently determined. When the DOS attack stops, the write protection to the first region can be removed to relax the access permission to the data of the first region.

In related technology, in a platform firmware protection and recovery (PFR) method, the flash device can be arranged under a Root of Trust controller. The controller can be configured to monitor the access to the flash device (including but not limited to the access of the platform firmware to the flash device). When the platform firmware is running, any violated access without authorization can be prohibited. However, in the related technology, the protection mechanism has shortcomings during running, and the platform firmware can be vulnerable to the DOS attack.

In the related technology, the access to the flash device can be monitored, and the flash device can be isolated from the application processor (e.g., BMC or PCH) through a switch, or the power source of the flash device can be directly removed when unauthorized access is detected.

The solution method of the related technology can be easily under DOS attacks during a violated access storm. Under the DOS attack, the flash device of the platform firmware can be isolated. Thus, the flash device cannot be accessed or powered on and off repeatedly to prevent the platform firmware from being accessed. Under the DOS attack, if the platform firmware needs to access the flash device, unexpected errors can occur to result in a loss of manageability and platform firmware failures.

The present disclosure provides a method for protecting the platform firmware from DOS attacks and minimizing the impact on the platform firmware (client application/workload running on top of the platform firmware). The method includes the following processes.
At S201, a DOS attack is detected according to an access mode.
At S202, when the DOS attack occurs, the flash device is set to a region protection mode, which is different from isolating the flash device from the application processor or removing the power source from the flash device.
At S203, the user is notified of the DOS attack.
At S204, the client resolves or detects that the DOS attack ends.
At S205, the flash device is restored to the normal mode.

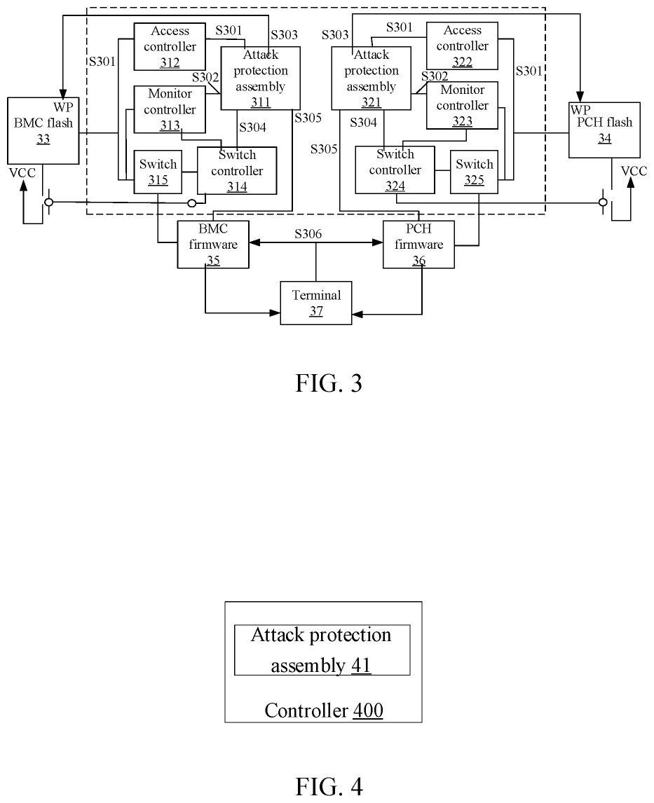

In embodiments of the present disclosure, a platform firmware protection and recovery method is provided and applied in a firmware protection system. As shown in FIG. 3, the firmware protection system includes a root of trust controller, a flash device, firmware, and a user terminal. The root of trust controller can include an attack protection assembly, a flash access controller, a monitoring controller, a switch controller, and a switch. The attack protection assembly includes an attack protection assembly 311 and an attack protection assembly 321. The flash access controller includes an access controller 312 and an access controller 322. The monitoring controller can include a monitoring controller 313 and a monitoring controller 323. The switch controller includes a switch controller 314 and a switch controller 324. The switch includes a switch 315 and a switch 325. The flash device includes a BMC flash 33 and a PCH flash 34. The firmware includes BMC firmware 35 and PCH firmware 36. The BMC flash 33 is used to store the BMC firmware 35, and the PCH flash 34 is used to store the PCH firmware 36. The user terminal includes a terminal 37.

The method includes the following processes.

At S301, the attack protection assembly configures a region protection mode for the flash device through the flash access controller according to the flash layout of the platform firmware.

The attack protection assembly 311 can configure the region protection mode for the BMC flash 33 through the access controller 312, and the attack protection assembly 321 can configure the region protection mode for the PCH flash 34 through the access controller 322.

At S302, when the platform firmware is running, the attack protection assembly reads attack statistic information and determines whether a DOS attack has occurred.

The attack statistic information can include the access mode and the access count of the access request. Whether the DOS attack has occurred can be determined according to the access mode and the access count. When the BMC firmware 35 is running, the attack protection assembly 311 can read the attack statistic information and determine that the DoS has occurred. When the PCH firmware 36 is running, the attack protection assembly 321 can read the attack statistic information and determine that the DOS attack has occurred.

At S303, the attack protection assembly asserts the WP Pins of the flash device to enter the region protection mode.

The attack protection assembly 311 can assert WP Pins of the BMC flash 33, and the BMC flash 33 can then enter the region protection mode. The attack protection assembly 321 can assert WP Pins of the PCH flash 34, and the PCH flash 34 can then enter the region protection mode.

At S304, the attack protection assembly requires the monitoring controller to no longer isolate the flash device or remove the power source from the flash device during running.

The attack protection assembly 311 can require, when the BMC firmware 35 is running, the monitoring controller 313 to no longer control the switch controller 314 to isolate the BMC flash 33 or remove the power source of the BMC flash 33 through the switch 315. The attack protection assembly 321 can require, when the PCH firmware 36 is running, the monitoring controller 323 to no longer control the switch controller 324 to isolate the PCH flash 34 or remove the power source of the PCH flash 34 through the switch 325.

At S305, the attack protection assembly notifies the firmware of the DOS attack.

The BMC firmware 35 can alert the terminal 37 regarding the violated access DoS attack on the BMC flash 33 and suggest how to inspect/resolve the violated access. The PCH firmware 36 can alert the terminal 37 regarding the violated access DOS attack on the PCH flash 34 and suggest how to inspect/resolve the violated access.

At S306, the attack protection assembly reads the attack statistic information and determines whether, or after the client resolves the attack, feedback is provided to the attack protection assembly, the WP pins of the flash device are de-asserted to exit the region protection mode.

The client can be the user using the user terminal. The attack protection assembly 311 or the attack protection assembly 321 can read the attack statistic information, determine that the DOS attack has stopped. In some other embodiments, after the client resolves the attack of the BMC flash 33 and provides the feedback to the attack protection assembly 311 through the terminal 37, the WP pins of the BMC flash 33 can be de-asserted, and the BMC flash 33 can exit the region protection mode. In some other embodiments, after the client resolves the attack of the PCH flash 34 and provides the feedback to the attack protection assembly 321 through the terminal 37, the WP pins of the PCH flash 34 can be de-asserted, and the PCH flash 34 can exit the region protection mode.

In related technologies, a server can defend against the DOS attack to isolate changes to UEFI of the platform in an authorized manner. However, since attacks always need to be determined, access issues (DOS attacks) can result. Embodiments of the present disclosure provide a method for protecting the platform firmware from the DoS attack of the violated access to the flash device, which can be integrated into a PFR solution and provide a relatively high-security protection value. After the attack is identified to belong to the DOS attack, the write protection region can be divided at the storage device to reduce the isolated region and lower the strength of the DOS attack.

In embodiments of the present disclosure, when the firmware protection method is realized in the form of a software functional module and sold or applied as an independent product, the method can also be stored in a computer-readable storage medium. Based on this understanding, the essential parts of the technical solution of embodiments of the present disclosure or the parts contributing to the related technology can be embodied in the form of a software product. The computer software product can be stored in a storage medium, including several instructions used to cause an electronic device (e.g., cell phone, tablet computer, desktop computer, personal digital assistant, navigation device, digital phone, video phone, TV, sensor device, etc.) to perform all or a part of the method of embodiments of the present disclosure. The storage medium can include various media that can store program codes, such as a USB drive, a portable hard drive, a read-only memory, disks, or optical discs. Thus, embodiments of the present disclosure are not limited to a specific combination of hardware and software.

FIG. 4 illustrates a schematic structural diagram of a controller 400 according to some embodiments of the present disclosure. As shown in FIG. 4, the controller 400 includes an attack protection assembly 41 configured to monitor the access request to the storage device and obtain the access request data. The storage device can be configured to store the firmware.

The attack protection assembly 41 can be further configured to, in response to the access request data, when the access request is determined to be the DOS attack, perform write protection on the first region of the storage device, maintain the power supply to the storage device, and allow the storage device to be accessed to allow the firmware to access the storage device.

In some embodiments, the attack protection assembly 41 can be further configured to divide the storage region of the storage device into the first region and the second region. At least a portion of the first region can be used to store the firmware.

In some embodiments, the first region can include a read-only region. The second region can include a read-write region. The attack protection assembly 41 can be further configured to divide the storage region of the storage device into a read-write region and a read-only region with sectors as units.

In some embodiments, the attack protection assembly 41 can be further configured to determine the access mode and the access count of the access request and determine that the access request is the DOS attack when the access mode is the violated access and the access count is greater than the predetermined threshold.

In some embodiments, the attack protection assembly 41 can be further configured to notify the firmware that the storage device is under the DOS attack to allow the firmware to notify the user of the inspection method and/or the resolution method of the DOS attack.

In some embodiments, the attack protection assembly 41 can be further configured to, when the access count is less than or equal to the predetermined threshold, determine that the DOS attack has stopped, and remove the write protection of the first region of the storage device.

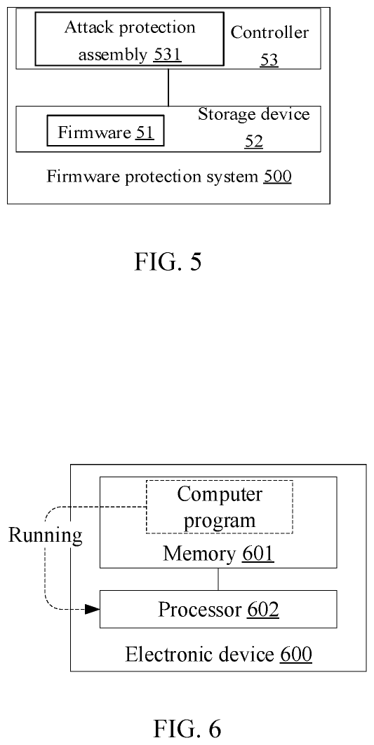

FIG. 5 illustrates a schematic structural diagram of another firmware protection system 500 according to some embodiments of the present disclosure. As shown in FIG. 5, the system 500 includes firmware 51, a storage device 52, and a controller 53.

The attack protection assembly 531 of the controller 53 can be configured to monitor the access request to the storage device 52 and obtain the access request data. The storage device 52 can be configured to store the firmware 51.

The attack protection assembly 531 can be configured to, in response to the access request data, when the access request is determined to be the DOS attack, perform the write protection on the first region of the storage device 52, maintain the power supply to the storage device 52, and allow the storage device 52 to be accessed to allow the firmware 51 to access the storage device 52.

The description of device embodiments is similar to the description of method embodiments and has similar beneficial effects to the method embodiments. For the technical details not disclosed in device embodiments of the present disclosure, reference can be made to the description of method embodiments of the present disclosure.

Correspondingly, embodiments of the present disclosure provide an electronic device. FIG. 6 illustrates a schematic diagram showing a hardware entity of an electronic device 600 according to some embodiments of the present disclosure. As shown in FIG. 6, the hardware entity of the device 600 includes a memory 601 and a processor 602. The memory 601 can be used to store the computer program that is executable at the processor 602. The processor 602 can be configured to execute the program to realize the steps of the firmware protection method of embodiments of the present disclosure.

The memory 601 can be used to store instructions and applications that can be executed by the processor 602 and cache data (e.g., image data, audio data, audio communication data, and video communication data) that is to be processed or has been processed by the processor 602 and modules of the device 600, which can be realized through flash or random access memory (RAM).

Correspondingly, embodiments of the present disclosure provide a computer-readable storage medium, which stores the computer program. When the computer program is executed by the processor, the steps of the firmware protection method of embodiments of the present disclosure can be realized.

The descriptions of storage medium embodiments and device embodiments are similar to the description of method embodiments and have similar beneficial effects as method embodiments. For technical details not disclosed in storage medium embodiments and method embodiments of the present disclosure, reference can be made to the description of device embodiments of the present disclosure.

Throughout the specification, the term “an embodiment” or “one embodiment” means that specific features, structures, or characteristics related to embodiments of the present disclosure are included in at least one embodiment of the present disclosure. Therefore, the term “in one embodiment” or “in an embodiment” throughout the specification does not necessarily refer to the same embodiment. Furthermore, the specific features, structures, or characteristics can be combined in any suitable manner in one or more embodiments. In various embodiments of the present disclosure, the sequence number of the above processes does not necessarily imply a specific execution order. The execution order of the processes should be determined according to the functionality and inherent logic of the processes, which does not limit the implementation process of embodiments of the present disclosure. The sequence number of embodiments of the present disclosure is merely for description and does not indicate the superiority or inferiority of embodiments of the present disclosure.

In the present disclosure, the terms “comprise,” “include,” or any other variations thereof are intended to encompass non-exclusive inclusion, such that processes, methods, articles, or devices comprising a series of elements include not only those elements but also other elements not explicitly listed, or even elements that are inherent to the processes, methods, articles, or devices. When there are no more limitations, an element specified by “comprising a . . . ” does not exclude the presence of additional identical elements in the processes, methods, articles, or devices comprising the element.

In some embodiments of the present disclosure, the disclosed devices and methods can be implemented in other methods. The above device embodiments are merely illustrative. For example, the division of the units is merely a logical functional division and other division methods can be used in actual implementations. For example, a plurality of units or assemblies can be combined or integrated into another system, or some features may be omitted or not executed. In addition, the coupling, direct coupling, or communication connection between the various members shown or discussed can be indirect coupling or communication connection through interfaces, devices, or units and can be electrical, mechanical, or in other forms.

The units described as separate members can or can not be physically separated. The members shown as units can or can not be physical units and can be located in one place or distributed across a plurality of network units. A part or all of the units can be selected as needed to achieve the objectives of the solution of embodiments of the present disclosure. In addition, various functional units of embodiments of the present disclosure can be integrated into one processing unit or individual units, respectively, or two or more units can be integrated into one unit. The integrated units can be implemented by hardware or the hardware with the software functional units.

Those of ordinary skill in the art can understand that all or a part of the steps of method embodiments can be completed through the program instructing related hardware. The program can be stored in a computer-readable storage medium. When the program is executed, the steps of method embodiments can be performed. The storage medium can include various media that can store program codes, such as a mobile storage device, a read-only memory (ROM), disks, or optical discs. In some other embodiments, when the integrated unit is realized in the form of a software functional module and sold or applied as an independent product, the integrated unit can also be stored in a computer-readable storage medium. Based on this understanding, the essential parts of the technical solution of embodiments of the present disclosure or the parts contributing to the related technology can be embodied in the form of a software product. The computer software product can be stored in a storage medium, including several instructions used to cause an electronic device (e.g., cell phone, tablet computer, desktop computer, personal digital assistant, navigation device, digital phone, video phone, TV, sensor device, etc.) to perform all or a part of the method of embodiments of the present disclosure. The storage medium can include various media that can store program codes, such as a USB drive, a portable hard drive, a read-only memory, disks, or optical discs.

The methods of method embodiments of the present disclosure can be combined arbitrarily when there is no conflict to obtain new method embodiments. Features disclosed in product embodiments of the present disclosure can be arbitrarily combined when there is no conflict to obtain new product embodiments. The methods of the present disclosure or features disclosed in device embodiments can be arbitrarily combined to obtain new method embodiments or device embodiments.

The above are merely embodiments of the present disclosure. However, the scope of the present disclosure is not limited to this. Those skilled in the art can easily think of changes or replacements within the technical scope of the present disclosure. These changes and replacements are within the scope of the present disclosure. Thus, the scope of the present disclosure is subject to the scope of the claims.

What is claimed is:

1. A firmware protection method comprising:
monitoring an access request to a storage device and obtaining access request data, the storage device being configured to store firmware; and
in response to the access request data, when determining that the access request is a denial-of-service (DOS) attack, performing write protection on a first region of the storage device, maintaining the power supply to the storage device, and allowing the storage device to be accessible to the firmware.

2. The method of claim 1, further comprising:
dividing a storage region of the storage device into the first region and a second region;
wherein a portion of the first region is used to store the firmware.

3. The method of claim 2, wherein:
the first region includes a read-only region, the second region includes a read-write region; and
dividing the storage region of the storage device into the first region and the second region includes:
dividing the storage region of the storage device into the read-write region and the read-only region in one or more sectors.

4. The method of claim 1, further comprising:
determining an access mode and an access count of the access request; and
when the access mode is violated access and the access count is greater than a predetermined threshold, determining the access request is the DOS attack.

5. The method of claim 4, further comprising:
in response to the access count being less than or equal to the predetermined threshold, determining that the DOS attack has stopped; and
removing the write protection from the first region of the storage device.

6. The method of claim 1, further comprising:
notifying the firmware that the storage device is under the DOS attack for the firmware to notify about an inspection method and/or a resolution method for the DOS attack.

7. A controller comprising:
an attack protection assembly configured to:
monitor an access request to a storage device and obtain access request data, the storage device being configured to store firmware; and
in response to the access request data, when determining that the access request is a denial-of-service (DOS) attack, perform write protection on a first region of the storage device, maintain power supply to the storage device, and allow the storage device to be accessed by the firmware.

8. The controller of claim 7, wherein:
the attack protection assembly is further configured to divide a storage region of the storage device into the first region and a second region; and
a portion of the first region is used to store the firmware.

9. The controller of claim 8, wherein:
the first region includes a read-only region, and the second region includes a read-write region; and
the attack protection assembly is further configured to:
divide the storage region of the storage device into the read-write region and the read-only region in one more sectors.

10. The controller of claim 7, wherein the attack protection assembly is further configured to:
determine an access mode and an access count of the access request; and
when the access mode is violated access and the access count is greater than a predetermined threshold, determine the access request as the DOS attack.

11. The controller of claim 10, wherein the attack protection assembly is further configured to:
in response to the access count being less than or equal to the predetermined threshold, determine that the DOS attack has stopped; and
remove the write protection from the first region of the storage device.

12. The controller of claim 7, wherein the attack protection assembly is further configured to:
notify the firmware that the storage device is under the DOS attack for the firmware to notify about an inspection method and/or a resolution method for the DOS attack.

13. An electronic device comprising:
a processor; and
a memory storing a computer program that, when executed by the processor, causes the processor to:
monitor an access request to a storage device and obtain access request data, the storage device being configured to store firmware; and
in response to the access request data, when determining that the access request is a denial-of-service (DOS) attack, perform write protection on a first region of the storage device, maintain power supply to the storage device, and allow the storage device to be accessed by the firmware.

14. The device of claim 13, wherein the processor is further configured to:
divide a storage region of the storage device into the first region and a second region, at least a portion of the first region being used to store the firmware.

15. The device of claim 14, wherein:
the first region includes a read-only region, the second region includes a read-write region; and
the processor is further configured to:
divide the storage region of the storage device into the read-write region and the read-only region in one or more sectors.

16. The device of claim 13, wherein the processor is further configured to:
determine an access mode and an access count of the access request; and
when the access mode is violated access and the access count is greater than a predetermined threshold, determine the access request as the DOS attack.

17. The device of claim 16, wherein the processor is further configured to:
in response to the access count being less than or equal to the predetermined threshold, determine that the DOS attack has stopped; and
remove the write protection from the first region of the storage device.

18. The device of claim 13, wherein the processor is further configured to:
notify the firmware that the storage device is under the DOS attack for the firmware to notify about an inspection method and/or a resolution method for the DOS attack.
